(19) United States
(12) Patent Application Publication
(10) Pub. No.: US 2017/0374690 A1
(43) Pub. Date: Dec. 28, 2017

(54) Indication of Attributes of Backhaul Connections of Access Points

(71) Applicant: QUALCOMM Incorporated, San Diego, CA (US)

(72) Inventors: Satish Maddali, Hyderabad (IN); Sreenivasula Reddy Danda, Hyderabad (IN); Janardhan Reddy Reddam, Hyderabad (IN); Pradeep Kumar Muvva, Hyderabad (IN); Naresh Kumar Gupta Varada, Hyderabad (IN)

(21) Appl. No.: 15/189,571

(22) Filed: Jun. 22, 2016

(51) Int. Cl. H04W 76/02; H04W 24/02; H04W 72/04; H04L 12/26; H04W 88/08; H04W 84/12

(52) U.S. Cl. CPC H04W 76/02; H04W 72/0486; H04L 43/12; H04L 43/10; H04W 24/02; H04W 84/12; H04W 88/08

(57) ABSTRACT

Embodiments include methods and devices enabling an access point to indicate an attribute of the backhaul connection of the access point. Embodiments include methods and devices for notifying a user of a computing device of backhaul connection attributes of available access points.

### BACKGROUND

Computing devices, such as mobile communication devices (e.g., smart phones, wearables, tablets, etc.), use a variety of air interface technologies (also known as radio access technologies) to connect to access points (often abbreviated as “APs” and sometimes also referred to as wireless access points (WAPs), hotspots, network hubs, network transceivers, base stations, or towers). Examples of air interface technologies that may be used by access points include wireless local area network (WLAN) technologies (e.g., Wi-Fi, etc.), cellular technologies (e.g., Third Generation (3G), Fourth Generation (4G), Long Term Evolution (LTE), etc.), and personal area network (PAN) technologies (e.g., Bluetooth, etc.). The access points typically connect to a router and/or other networking hardware (singularly or in various networked configurations) to establish connections to the Internet via a core network providing Internet connectivity. The core network is often referred to as a backbone network, and the connection of the access point to the Internet is often referred to as a backhaul connection.

When an access point has a backhaul connection, the connection between the access point and a computing device, such as a mobile communication device, provides the computing device with Internet access. When the access point does not have a backhaul connection, Internet access cannot be provided to the computing device even though the access point and a computing device have established a connection. However, this situation may not be recognized by a user connecting to the access point until an application is unable to access the Internet.

### SUMMARY

Systems, methods, and devices of various embodiments enable an access point to determine and indicate an attribute of the backhaul connection of the access point to facilitate selecting an access point for use. Various embodiments may include an access point determining an attribute of a backhaul connection of an access point, in which the backhaul connection is an Internet Protocol connection that provides a communication pathway via a core network between the access point and World Wide Web addresses, generating an advertisement message including the attribute of the backhaul connection, and broadcasting the advertisement message.

In some embodiments, the access point may be a Wi-Fi access point and the advertisement message may be a beacon frame or probe response frame. In some embodiments, the access point may be a Bluetooth access point and the advertisement message may be an availability advertisement. In some embodiments, the advertisement message may be broadcast prior to establishment of a connection with the access point.

In some embodiments, determining the attribute of the backhaul connection of the access point includes the access point pinging a World Wide Web addressable device over the backhaul connection, and determining the attribute based on the response to the ping.

In some embodiments, the attribute of the backhaul connection may be an indication of whether a packet was successfully received from a World Wide Web addressable device remote from the access point over the backhaul connection. In some embodiments, the attribute of the backhaul connection may be a bandwidth of the backhaul connection. In some embodiments, the attribute of the backhaul connection may be a bit rate of the backhaul connection. In some embodiments, the attribute of the backhaul connection may be a type of the backhaul connection. In some embodiments, the type of the backhaul connection may be wired or wireless.

Various embodiments may further include determining a capability of the access point, and generating the advertisement message including the attribute of the backhaul connection may include including the bit rate of the backhaul connection and the capability of the access point in the generated advertisement message. In some embodiments, the capability of the access point may be one or more of a channel load of the access point or a number of devices connected to the access point.

Systems, methods, and devices of various embodiments enable notifying a user of a computing device of backhaul connection attributes of available access points. Various embodiments may include receiving a first advertisement message broadcast from a first access point, in which the first advertisement message includes an indication of an attribute of a backhaul connection of the first access point and in which the backhaul connection of the first access point is an Internet Protocol connection that provides a first communication pathway via a first core network between the first access point and the World Wide Web, and displaying a first icon corresponding to the attribute of the backhaul connection of the first access point prior to establishing a connection with the first access point.

Various embodiments may further include receiving a second advertisement message broadcast form a second access point, wherein the second message includes an indication of an attribute of a backhaul connection of the second access point and wherein the backhaul connection of the second access point may be an Internet Protocol connection that provides a second communication pathway via a second core network to the World Wide Web, and displaying a second icon corresponding to the attribute of the backhaul connection of the second access point, wherein the first icon and the second icon are displayed in a list of available access points.

In some embodiments, the attribute of the backhaul connection of the first access point and the attribute of the backhaul connection of the second access point are bandwidths or bit rates of the backhaul connection.

In some embodiments, the first advertisement message may include a first capability of the first access point and the second advertisement message may include a second capability of the second access point. Various embodiments may further include sorting the list of available access points based at least in part on the attribute of the backhaul connection of the first access point, the first capability, the attribute of the backhaul connection of the second access point, and the second capability. In some embodiments, sorting the list of available access points may be based on a result of applying a weighted sorting algorithm to the attribute of the backhaul connection of the first access point, the first capability, the attribute of the backhaul connection of the second access point, and the second capability.

In some embodiments, the attribute of the backhaul connection of the first access point and the attribute of the backhaul connection of the second access point are one or more of bandwidths, bit rates, and types. In some embodiments, the first capability may be one or more of a channel load of the first access point and a number of devices connected to the first access point. In some embodiments, the second capability may be one or more of a channel load of the second access point and a number of devices connected to the second access point.

Various embodiments include an access point including a processor configured with processor-executable instructions to perform operations of the methods summarized above. Various embodiments include a computing device including a processor configured with processor-executable instructions to perform operations of the methods summarized above. Various embodiments also include a non-transitory processor-readable storage medium having stored thereon processor-executable software instructions configured to cause a processor to perform operations of the methods summarized above. Various embodiments also include an access point that includes means for performing functions of the methods summarized above. Various embodiments also include a computing device that includes means for performing functions of the methods summarized above.

### BRIEF DESCRIPTION OF THE DRAWINGS

The accompanying drawings, which are incorporated herein and constitute part of this specification, illustrate various embodiments, and together with the general description given above and the detailed description given below, serve to explain the features of various embodiments.

FIG. 1 is a system block diagram of a communication environment in which the various embodiments may be used.

FIG. 2 is a component block diagram illustrating an access point suitable for use with various embodiments.

FIG. 3 is a component block diagram illustrating a computing device suitable for use with various embodiments.

FIG. 4 is a process flow diagram illustrating a method for indicating an attribute of a backhaul connection of an access point according to various embodiments.

FIG. 5 is a process flow diagram illustrating a method for indicating an attribute of a backhaul connection of an access point according to various embodiments.

FIG. 6 is a process flow diagram illustrating a method for notifying a user of a computing device of backhaul connection attributes of an available access point according to various embodiments.

FIG. 7A is a block diagram illustrating an example icon for use with various embodiments.

FIG. 7B is a block diagram illustrating an example icon for use with various embodiments.

FIG. 8 is a process flow diagram illustrating a method for notifying a user of a computing device of backhaul connection attributes of an available access point according to various embodiments.

FIG. 9 is a process flow diagram illustrating a method for notifying a user of a computing device of backhaul connection attributes of an available access point according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of various embodiments or the claims.

Various embodiments provide methods for communicating backhaul capabilities of a wireless access point and displaying such capabilities to a user on a computing device. Various embodiments may solve the technical problem of connecting to wireless access points that do not have a backhaul connection by communicating backhaul capabilities of a wireless access point and displaying such capabilities to a user on a computing device, thereby enabling connections to be established with wireless access points that do have a backhaul connection.

The term “access point” is used herein to refer to any device that connects to a router and/or other networking hardware (singularly or in various networked configurations) to establish one or more connections to the Internet via a core network (also referred to as a backbone network) providing Internet connectivity and that makes the established one or more connections to the Internet via a core network providing Internet connectivity available to one or more computing device via one or more connections established using one or more air interface technologies. Access points may be abbreviated as “APs” and sometimes referred to as wireless access points (WAPs), hotspots, network hubs, network transceivers, base stations, or towers by those of ordinary skill in the art. The connection of the access point to the Internet (or core network or backbone network providing Internet connectivity) may be referred to herein as a “backhaul connection.”

The term “computing device” is used herein to refer to any one or all of mobile communication devices (e.g., cellular telephones, smart phones, wearables, etc.), personal or mobile multi-media players, personal data assistants (PDAs), laptop computers, personal computers, tablet computers, smart books, palm-top computers, wireless electronic mail receivers, wireless gaming controllers, wearable devices, implantable devices, streaming media players, smart televisions, digital video recorders (DVRs), and similar personal electronic devices which include a programmable processor and memory and circuitry for using one or more of a variety of air interface technologies.

Access points and computing devices may establish a wireless connection using any of a variety of air interface technologies, including for example wireless local area network (WLAN) technologies (e.g., Wi-Fi, etc.), cellular technologies (e.g., Third Generation (3G), Fourth Generation (4G), Long Term Evolution (LTE), etc.), and personal area network (PAN) technologies (e.g., Bluetooth, etc.). Access points may connect to a router and/or other networking hardware (singularly or in various networked configurations) to establish connections to the Internet via a core network providing Internet connectivity. The connection of the access point to the Internet may be referred to as a backhaul connection. When the access point has a backhaul connection, the connection between the access point and a computing device provides the computing device with Internet access. When the access point does not have a backhaul connection, even though the access point and a computing device may have established a connection, Internet access is not provided to the computing device.

The term “World Wide Web” is used herein to refer to the collection of Internet accessible resources stored on Internet connected devices and identified by addresses, such as Uniform Resource Identifiers (URIs) or Uniform Resource Locators (URLs). The addresses of Internet accessible resources are referred to herein generally as “World Wide Web addresses” and the Internet connected devices storing the Internet accessible resources are referred to herein generally as “World Wide Web addressable devices.”

The term “component” is intended to include a computer-related part, functionality or entity, such as, but not limited to, hardware, firmware, a combination of hardware and software, software, or software in execution, that is configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

Typically, a computing device, such as a mobile communication device, will identify available access points based upon received wireless signals. For example, a Wi-Fi connection as defined by the Institute of Electrical and Electronics Engineers (IEEE) 802.11 series specifications can be established by a mobile communication device (also referred to as a station (STA) or non-AP STA in the IEEE 802.11 series specifications) transmitting a probe request frame (or message), each access point receiving the probe request responding with a probe response frame (or message) including that access point's respective service set identifier (SSID), and the computing device selecting one of the access points with which to establish a data connection. The probe response frame (or message) indicates various capabilities of the access point and the network, including signal strength measurements (e.g., received signal strength indication (RSSI), current channel used by the access point, the channel load (e.g., current number of access points using the same channel), the access point load (e.g., current number of devices connected to the access point), etc.

Typically, a listing of available access points (sometimes referred to as an service set identifier (SSID) list or AP list) is displayed to a user of a computing device, for example in a drop down menu. Depending on user settings, the listing of available access points may displayed in order of relative signal strength (RSSI) (e.g., sorted by RSSI), with signal strength indication icons in the listing of available access points (e.g., graphs of RSSI next to each SSID). The raw sorting of available access points based only on signal strength does not inform the user regarding whether or not the access point can provide a connection to the Internet (i.e., a backhaul connection).

With available access points identified, the computing device will establish a wireless connection with one access point. The selection of one access point for establishing a wireless connection may be performed automatically by the computing device, such as based on signal strength, past connections or open availability, or may be performed in response to a user selection. A connection to the selected access point is then accomplished according to the wireless communication protocol (e.g., WiFi). Once the connection to the selected access point is established, the computing device sends/receives data to/from the access point. If the access point has a backhaul connection, the access point relays communications and data to/from the Internet. However, if the access point turns out to not have a backhaul connection, attempts by the computing device to access a service available via the Internet (e.g., email), will result in an error message. Given the time required to select and connect to an access point, the user may be frustrated by connecting to an access point that does not provide an Internet connection (i.e., a backhaul connection), particularly when there are several access point from which to choose.

Systems, methods, and devices of various embodiments enable an access point to indicate an attribute of a backhaul connection of the access point. In various embodiments, an access point may determine one or more attributes of a backhaul connection of the access point. The backhaul connection of the access point may be an Internet Protocol connection that provides a communication pathway via a core network between the access point and World Wide Web address. Thus, the backhaul connection of the access point enables the access point to communicate with one or more World Wide Web addressable devices, such as one or more servers (e.g., web servers, etc.).

In various embodiments, the one or more attributes of the backhaul connection of the access point may be bandwidth of the backhaul connection, a bit rate of the backhaul connection, a type of the backhaul connection (e.g., wired or wireless), an indication that a packet was successfully received from a World Wide Web addressable device remote from the access point over the backhaul connection, and/or any other attribute of the backhaul connection determinable by the access point. In various embodiments, the access point may determine one or more attribute of the backhaul connection by pinging a World Wide Web addressable device over the backhaul connection and determining the attribute based at least in part on a response to the ping. In various embodiments, the access point may determine a capability of the access point, such as one or more of a channel load of the access point or a number of devices connected to the access point.

In various embodiments, an access point may generate an advertisement message including one or more attributes of the backhaul connection. The access point may generate the advertisement message to include one or more attributes of the backhaul connection and/or one or more capabilities of the access point. In various embodiments, the advertisement message may be generated in a specific format according to the type of access point generating the advertisement message. For example, a Wi-Fi type access point may generate the advertisement message as a beacon frame or probe response frame including the one or more attributes of the backhaul connection. As another example, a Bluetooth access point may generate the advertisement message as an availability advertisement including the one or more attributes of the backhaul connection.

In various embodiments, an access point may broadcast the advertisement message via one or more air interface technologies. As examples, a Wi-Fi type access point may broadcast an advertisement message as a beacon frame or probe response frame over one or more Wi-Fi channels and a Bluetooth type access point may broadcast an advertisement message as an availability advertisement over one or more Bluetooth channels. The advertisement message may be broadcast prior to the establishment of a connection between the access point and a computing device.

Systems, methods, and devices of various embodiments enable notifying a user of a computing device of backhaul connection attributes of available access points. A computing device may include receiving one or more advertisement messages broadcast from one or more access points. In various embodiments, the computing device may display one or more icons (or other visual representation) corresponding to one or more attributes of the backhaul connections of the one or more access points indicated in the advertisement messages. For example, the one or more icons may be displayed in a list of available access points, such as a SSID list. The one or more icons or other visual representations may correspond to one or more attributes of the backhaul connections of the one or more access points and one or more capabilities of the access points indicated in the advertisement messages. Displaying the one or more icons or other visual representations enables users of computing devices to quickly and easily be informed about the access points that will provide an Internet connection and those that will not. Thus, the users may avoid selecting access points that will not provide a connection to the Internet.

In various embodiments, the computing device may sort the list of available access points based at least in part on the one or more attributes of the backhaul connections and/or the one or more capabilities of the access points. For example, the computing device may sort the listing of SSIDs for display (or provide an indication) to the user based on attributes of the backhaul connections, as well as RSSIs. A computing device may use a sorting algorithm based on one or more attributes and/or one or more capabilities of the access points that are indicated to the computing device (e.g., in beacon frames, probe response frames, availability advertisements, etc.), or otherwise determinable by the computing device, to rank, order, and/or prioritize the access points. The attributes of a backhaul connection may be used as inputs to a weighted sorting algorithm For example, each attribute or capability of each respective available access point identified by the computing device may be multiplied by a weight (or percentage) and the resulting value output by the algorithm for each respective available access point may be used to sort the available access points in the list of available access points displayed to the user. The weights may be pre-assigned and/or user selectable.

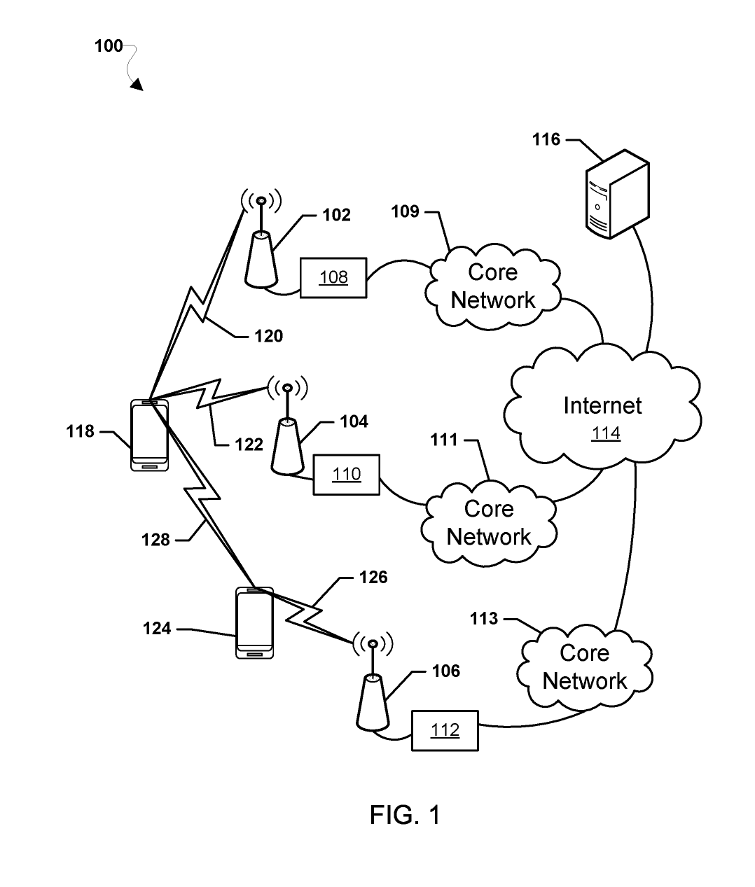

Various embodiments may be implemented in one or more access points and/or computing devices that may operate within a variety of communication environments, an example of which is illustrated in FIG. 1. A communication environment 100 may include one or more access points 102, 104, and 106 connected to one or more routers and/or other networking hardware 108, 110, and 112, respectively, one or more computing devices 118 and 124, and one or more World Wide Web addressable devices 116. The access points 102, 104, and 106 may be any type access points, such as WLAN access points (e.g., Wi-Fi access points, etc.), cellular access points (e.g., 3G access points, 4G access points, LTE access points, etc.), and PAN access points (e.g., Bluetooth access points, etc.).

The access points 102, 104, and 106 may be connected to one or more routers and/or other networking hardware 108, 110, and 112, respectively, such that the access points 102, 104, and 106 may establish one or more connections to core networks 109, 111, and 113, respectively, via the routers and/or other networking hardware 108, 110, and 112. Core networks 109, 111, and 113 may connect to the Internet 114. Core networks 109, 111, and 113 may be any type of network, such as cellular networks, cable networks, etc. The respective connections via the routers and/or other networking hard 108, 110, and 112 and the core networks 109, 111, and 113 to the Internet may constitute the backhaul connections for the access points 102, 104, and 106, respectively. The types of the backhaul connections for the access points 102, 104, and 106 may be wired or wireless connections. The access points 102, 104, and 106 may use the respective backhaul connections to communicate with the World Wide Web addressable device 116. For example, the access points 102, 104, and 106 may send and receive communications (e.g., Hypertext Transfer Protocol (HTTP) messages, etc.) with the World Wide Web addressable device 116 via the respective backhaul connections.

In addition to dedicated access points, the communication environment 100 may include one or more computing devices 124 that may be configured to function as an access point. For example, a computing device 124 may be configured to operate intermittently as a Wi-Fi hotspot. The computing device 124 may connect to access point 126 via a wireless (e.g., Wi-Fi) connection 126 according to one or more air interface technology (also known as radio access technologies), including for example WLAN technologies (e.g., Wi-Fi, etc.), cellular technologies (e.g., 3G, 4G, LTE, etc.), and PAN technologies (e.g., Bluetooth, etc.). The backhaul connection for the computing device 124 operating as an access point may include the wireless connection 126, the connection of the access point 126 to the router or other networking hardware 112, and connections to the Internet 114 via the core network 113. Thus, the backhaul connection of the computing device 124 operating as an access point may be a wireless connection because the backhaul includes wireless connection 126. The computing device 124 may use the backhaul connection to communicate with the World Wide Web addressable device 116. For example, the computing device 124 may send and receive communications (e.g., Hypertext Transfer Protocol (HTTP) messages, etc.) with the World Wide Web addressable device 116 via the backhaul connection.

The World Wide Web addressable device 116 may be a web server hosting a web page assigned a specific World Wide Web address. The access points 102, 104, and 106, as well as the computing device 124 configured to function as an access point, may communicate with the World Wide Web addressable device 116 to confirm that the respective backhaul connections of the access points 102, 104, and 106 and the computing device 124 are operating to provide an Internet Protocol connection to the Internet 114. A successful communication (e.g., a successful ping, successful download of a web page, etc.) between the World Wide Web addressable device 116 and the access points 102, 104, and 106 and the computing device 124 may indicate that a connection to the Internet 114 is available. Additionally, the successful communication may enable the access points 102, 104, and 106 and the computing device 124 configured to function as an access point to determine one or more attribute of the backhaul connections. An unsuccessful communication (e.g., a failed ping, failed download of a web page, etc.) between the World Wide Web addressable device 116 and the access points 102, 104, and 106 and the computing device 124 may indicate that no connection to the Internet 114 is provided. Additionally, the unsuccessful communication may enable the access points 102, 104, and 106 and the computing device 124 to determine one or more attribute of the backhaul connections.

The access points 102, 104, and 106, as well as the computing device 124 configured to function as an access point, may use one or more air interface technologies (e.g., WLAN technologies (e.g., Wi-Fi, etc.), cellular technologies (e.g., 3G, 4G, LTE, etc.), and PAN technologies (e.g., Bluetooth, etc.)) to establish one or more wireless connections 120, 122, and 128 to the computing device 118. The access points 102, 104, and 106, as well as the computing device 124 configured to function as an access point, may broadcast advertisement messages (e.g., beacon frames, probe response frames, availability advertisements, etc.) that the computing device 118 may receive. The advertisement messages may include one or more attributes of the backhaul connections, and/or one or more capabilities, of the access points 102, 104, and 106, as well as the computing device 124 configured to function as an access point.

The computing device 118 may display icons or other visual representations corresponding to the attributes of the backhaul connections, and/or the capabilities, of the access points 102, 104, and 106, as well as the computing device 124 configured to function as an access point.

A user of the computing device 118 may select one or more of the access points 102, 104, and 106 and/or the computing device 124 configured to function as an access point, with which to establish a connection 120, 122, and 124. Via the connections 120, 122, and 124 to one or more of the access points 102, 104, and 106 and/or the computing device 124 configured to function as an access point, the computing device 118 may send and/or receive data via the Internet 114 by leveraging the backhaul connections of the selected one or more of the access points 102, 104, and 106 and/or the computing device 124 configured to function as an access point.

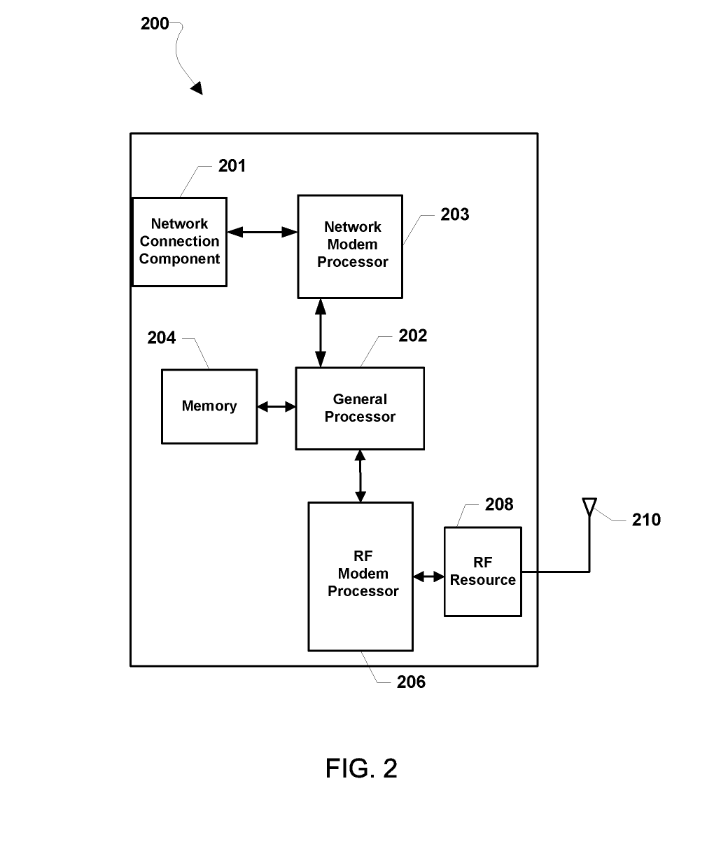

FIG. 2 is a component block diagram of an access point 200 suitable for implementing various embodiments. With reference to FIGS. 1 and 2, in various embodiments, the access point 200 may be similar to the access points 102, 104, and 106 and/or the computing device 124 configured to function as an access point.

The access point 200 may include at least one processor, such as a general processor 202, which may be coupled to at least one memory 204. The memory 204 may be a non-transitory computer-readable storage medium that stores processor-executable instructions. The memory 204 may store an operating system, user application software, and/or other executable instructions. The memory 204 may also store application data, such as an array data structure. The memory 204 may include one or more caches, read only memory (ROM), random access memory (RAM), electrically erasable programmable ROM (EEPROM), static RAM (SRAM), dynamic RAM (DRAM), or other types of memory. The general processor 202 may read and write information to and from the memory 204. The memory 204 may also store instructions associated with one or more protocol stacks. A protocol stack generally includes computer executable instructions to enable communication using a radio access protocol or communication protocol.

The processor 202 and the memory 204 may communicate with at least one radio frequency (RF) modem processor 206. The RF modem processor 206 may perform modem functions for communications with one or more other computing devices, and other such devices. The RF modem processor 206 may be coupled to an RF resource 208. The RF resource 208 may include various circuitry and components to enable the sending, receiving, and processing of radio signals, such as a modulator/demodulator component, a power amplifier, a gain stage, a digital signal processor (DSP), a signal amplifier, a filter, and other such components. The RF resource 208 may be coupled to a wireless antenna (e.g., a wireless antenna 210). The access point 200 may include additional RF resources and/or antennas without limitation. The RF resource 208 may be configured to provide communications using one or more frequency bands via the antenna 210.

The processor 202 and the memory 204 may communicate with at least one network modem processor 203. The network modem processor 203 may perform modem functions for communications with one or more other routers and/or other networking hardware, one or more other access points, or other such devices.

The network modem processor 203 may be coupled to a network connection component 201. The network connection component 201 may include various circuitry and components to enable the sending, receiving, and processing of signals, such as a modulator/demodulator component, a power amplifier, a gain stage, a digital signal processor (DSP), a signal amplifier, a filter, and other such components. The network connection component 201 may provide a wired or wireless connection to one or more other routers and/or other networking hardware, one or more other access points, or other such devices. The access point 200 may include additional network connection components without limitation. The network connection component 201 may be configured to provide communications to and from a core network of the access point 200.

The access point 200 may also include a bus for connecting the various components of the access point 200 together, as well as hardware and/or software interfaces to enable communication among the various components. The access point 200 may also include various other components not illustrated in FIG. 2. For example, the access point 200 may include a number of input, output, and processing components such as buttons, lights, switches, antennas, display screen or touchscreen, various connection ports, additional processors or integrated circuits, and many other components.

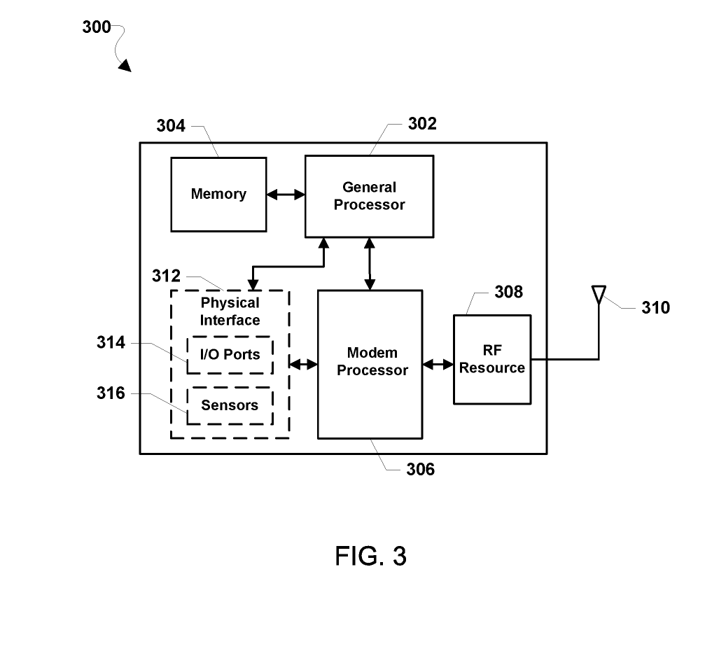

FIG. 3 is a component block diagram of a computing device 300 suitable for implementing various embodiments. The computing device 300 may be similar to the computing device 118 of FIG. 1.

The computing device 300 may include at least one processor, such as a general processor 302, which may be coupled to at least one memory 304. The memory 304 may be a non-transitory computer-readable storage medium that stores processor-executable instructions. The memory 304 may store an operating system, user application software, and/or other executable instructions. The memory 304 may also store application data, such as an array data structure. The memory 304 may be or include one or more caches, ROM, RAM, EEPROM, SRAM, DRAM, or other types of memory. The general processor 202 may read and write information to and from the memory 304. The memory 304 may also store instructions associated with one or more protocol stacks. A protocol stack generally includes computer executable instructions to enable communication using a radio access protocol or communication protocol.

The processor 302 and the memory 304 may communicate with at least one RF modem processor 306. The modem processor 306 may perform modem functions for communications with one or more other computing devices, one or more other access points, and other such devices. The modem processor 306 may be coupled to an RF resource 208. The RF resource 308 may include various circuitry and components to enable the sending, receiving, and processing of radio signals, such as a modulator/demodulator component, a power amplifier, a gain stage, a digital signal processor (DSP), a signal amplifier, a filter, and other such components. The RF resource 308 may be coupled to a wireless antenna (e.g., a wireless antenna 310). The computing device 300 may include additional RF resources and/or antennas without limitation. The RF resource 308 may be configured to provide communications using one or more frequency bands via the antenna 310.

In some embodiments, the processor 302 may also communicate with a physical interface 312 configured to enable a wired connection to another device. The physical interface 312 may include one or more input/output (I/O) ports 314 configured to enable communications with the device to which the computing device 300 is connected. The physical interface 312 may also include one or more sensors 316 to enable the wireless network node to detect information.

The computing device 300 may also include a bus for connecting the various components of the computing device 300 together, as well as hardware and/or software interfaces to enable communication among the various components. The computing device 300 may also include various other components not illustrated in FIG. 3. For example, the computing device 300 may include a number of input, output, and processing components such as buttons, lights, switches, antennas, display screen or touchscreen, various connection ports, additional processors or integrated circuits, and many other components.

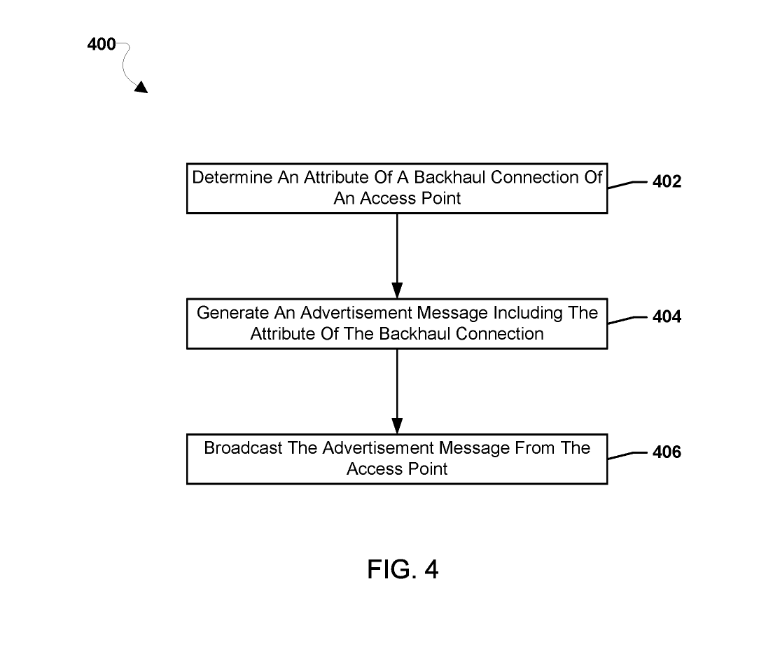

FIG. 4 is a process flow diagram illustrating a method 400 for indicating an attribute of a backhaul connection of an access point according to various embodiments. With reference to FIGS. 1-4, the method 400 may be implemented by a processor (e.g., the general processor 202 or another similar processor) of an access point (e.g., the access points 102, 104, 106, 200) and/or computing device configured to function as an access point (e.g., computing device 124).

In block 402, the processor may determine an attribute of a backhaul connection of an access point. In some examples, the backhaul connection may be an Internet Protocol connection that provides a communication pathway via a core network between the access point and World Wide Web addresses. In various embodiments, the one or more attributes of the backhaul connection of the access point may include, for example, bandwidth of the backhaul connection, a bit rate of the backhaul connection, a type of the backhaul connection (e.g., wired or wireless), an indication that a packet was successfully received from a World Wide Web addressable device remote from the access point over the backhaul connection, and/or any other attribute of the backhaul connection determinable by the access point. In some embodiments, the access point may determine one or more attribute of the backhaul connection by pinging a World Wide Web addressable device over the backhaul connection and determining the attribute based at least in part on a response to the ping.

In block 404, the processor may generate an advertisement message including the attribute of the backhaul connection. The type of the advertisement message may be associated with a type of the access point. For example, a Wi-Fi type access point may generate the advertisement message as a beacon frame or probe response frame including the attribute of the backhaul connection. As another example, a Bluetooth access point may generate the advertisement message as an availability advertisement including the attribute of the backhaul connection.

In block 406, the processor may broadcast the advertisement message from the access point. As examples, a Wi-Fi type access point may broadcast an advertisement message as a beacon frame or probe response frame over one or more Wi-Fi channels and a Bluetooth type access point may broadcast an advertisement message as an availability advertisement over one or more Bluetooth channels. The advertisement message may be broadcast prior to the establishment of a connection between the access point and a computing device.

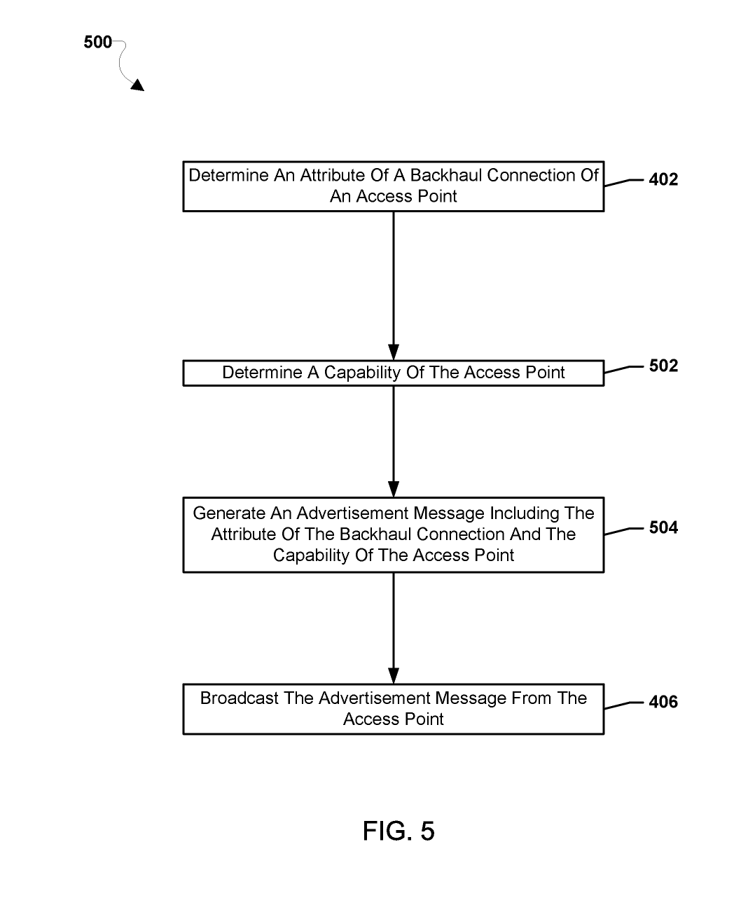

FIG. 5 is a process flow diagram illustrating a method 500 for indicating an attribute of a backhaul connection of an access point according to various embodiments. With reference to FIGS. 1-5, the method 500 may be implemented by a processor (e.g., the general processor 202 or another similar processor) of an access point (e.g., the access points 102, 104, 106, 200) and/or computing device configured to function as an access point (e.g., computing device 124).

In block 402, the processor may determine an attribute of a backhaul connection of an access point. In some examples, the backhaul connection is an Internet Protocol connection that provides a communication pathway via a core network between the access point and World Wide Web addresses. In various embodiments, the one or more attributes of the backhaul connection of the access point may include, for example, bandwidth of the backhaul connection, a bit rate of the backhaul connection, a type of the backhaul connection (e.g., wired or wireless), an indication that a packet was successfully received from a World Wide Web addressable device remote from the access point over the backhaul connection, and/or any other attribute of the backhaul connection determinable by the access point. In some embodiments, the access point may determine one or more attribute of the backhaul connection by pinging a World Wide Web addressable device over the backhaul connection and determining the attribute based at least in part on a response to the ping.

In block 502, the processor may determine a capability of the access point. In various embodiments, a capability of the access point may be one or more of a channel load of the access points or a number of devices connected to the access point.

In block 504, the processor may generate an advertisement message including the attribute of the backhaul connection and the capability of the access point. In various embodiments, a type of the advertisement message may be associated with a type of the access point. For example, a Wi-Fi type access point may generate the advertisement message as a beacon frame or probe response frame including the attribute of the backhaul connection and the capability of the access point. As another example, a Bluetooth access point may generate the advertisement message as an availability advertisement including the attribute of the backhaul connection and the capability of the access point.

In block 406, the processor may broadcast the advertisement message from the access point. As examples, a Wi-Fi type access point may broadcast an advertisement message as a beacon frame or probe response frame over one or more Wi-Fi channels and a Bluetooth type access point may broadcast an advertisement message as an availability advertisement over one or more Bluetooth channels. In various embodiments, the advertisement message may be broadcast prior to the establishment of a connection between the access point and a computing device.

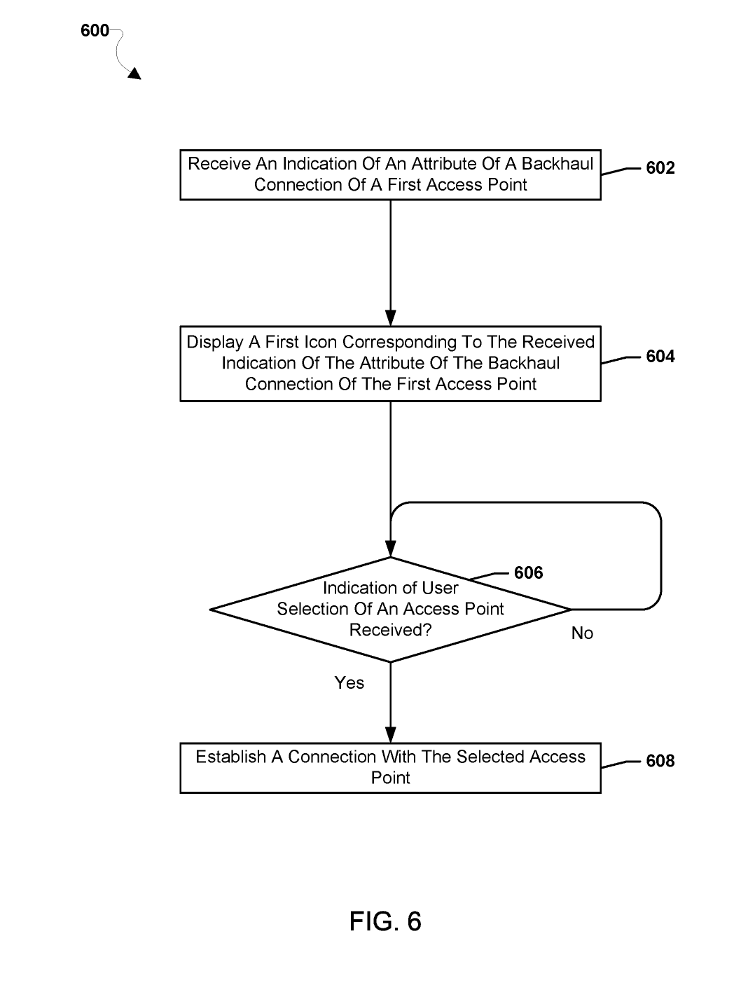

FIG. 6 is a process flow diagram illustrating a method 600 for notifying a user of a computing device of backhaul connection attributes of an available access point according to various embodiments. With reference to FIGS. 1-6, the method 600 may be implemented by a processor (e.g., the general processor 302 or another similar processor) of a computing device (e.g., the computing devices 118, 300).

In block 602, the processor may receive an indication of an attribute of a backhaul connection of a first access point. For example, in block 602, the processor may receive a first advertisement message broadcast from a first access point. In some embodiments, the first advertisement message may include an indication of an attribute of a backhaul connection of the first access point. In one example, the backhaul connection of the first access point is an Internet Protocol connection that provides a first communication pathway via a first core network between the first access point and the World Wide Web. For example, the computing device may receive an advertisement message as a beacon frame or probe response frame over one or more Wi-Fi channels from a Wi-Fi access point. The beacon frame or probe response frame may indicate the attribute of the backhaul connection of the access point. For example, the computing device may receive an advertisement message as an availability advertisement over one or more Bluetooth channels from a Bluetooth access point. The availability advertisement may indicate the attribute of the backhaul connection of the access point.

In block 604, the processor may display a first icon corresponding to the received indication of the attribute of the backhaul connection of the first access point. For example, the processor may display a first icon corresponding to the attribute of the backhaul connection of the first access point indicated in an advertisement message. The icon may be displayed prior to establishing a connection with the first access point. For example, the icon may be displayed in a list of available access points, such as an SSID list. In various embodiments, the icon may correspond to the attribute of the backhaul connection of the first access point indicated in the advertisement message. The display of the icon may enable users of the computing device to quickly and easily be informed regarding whether or not the access point will provide an Internet connection. Thus, the user may avoid connecting to an access point that will not provide a connection to the Internet.

In determination block 606, the processor may determine whether an indication of a user selection of an access point is received. In response to determining an indication of a user selection of an access point is not received (i.e., determination block 606=“No”), the processor may continue to determine whether an indication of a user selection of an access point is received in determination block 606.

In response to determining an indication of a user selection of an access point is received (i.e., determination block 606=“Yes”), the processor may establish a connection with the selected access point in block 608. In various embodiments, the computing device and selected access point may exchange data via the established connection. In this manner, via the connection between the selected access point and the computing device, the computing device may send/receive data to the Internet when the selected access point's backhaul connection provides an Internet connection.

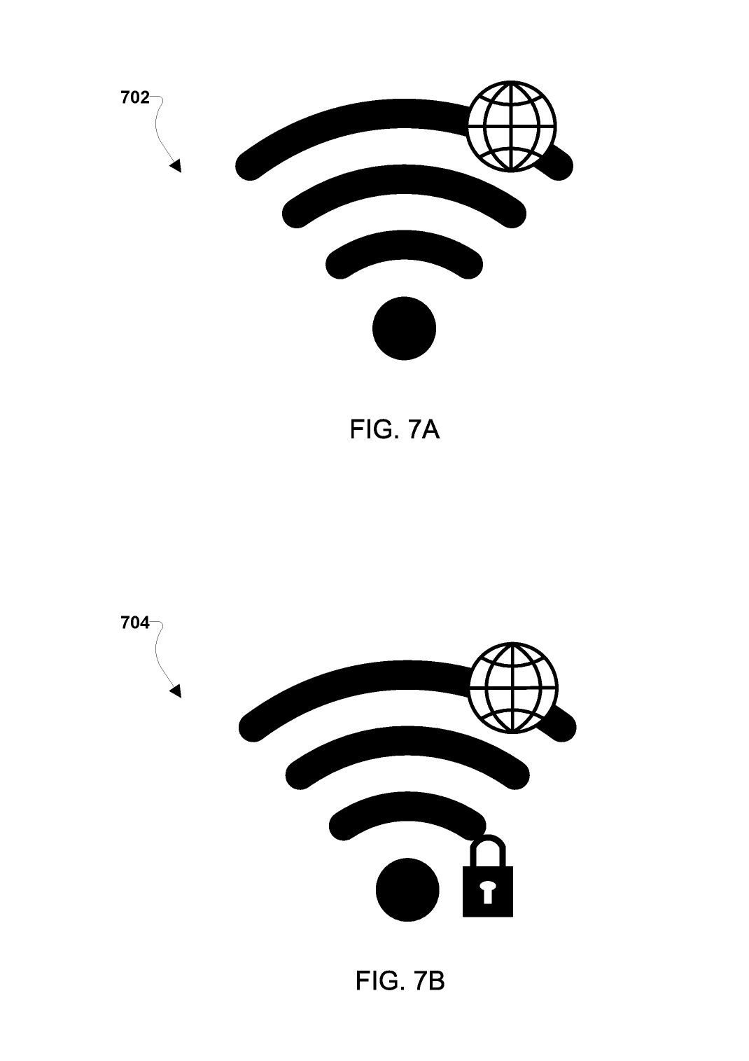

FIG. 7A is an illustration of an example icon 702 for use with various embodiments. With reference to FIGS. 1-7A, the icon 702 may be displayed by a computing device (e.g., the computing devices 118, 300) to indicate to a user of the computing device that an access point (e.g., the access points 102, 104, 106, 200) and/or computing device configured to function as an access point (e.g., computing device 124) associated with the icon 702 provides an unsecured backhaul connection to the Internet.

FIG. 7B is an illustration of an example icon 704 for use with various embodiments. With reference to FIGS. 1-7B, the icon 704 may be displayed by a computing device (e.g., the computing devices 118, 300) to indicate to a user of the computing device that an access point (e.g., the access points 102, 104, 106, 200) and/or computing device configured to function as an access point (e.g., computing device 124) associated with the icon 704 may provide an secured backhaul connection to the Internet.

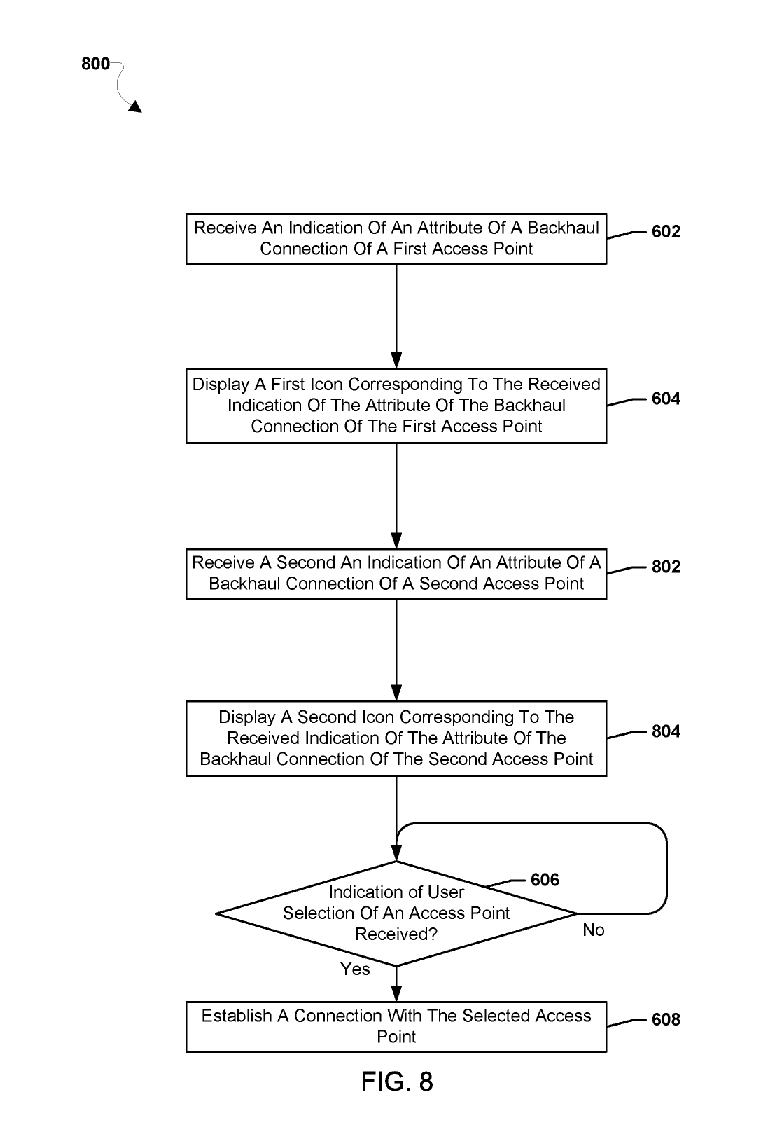

FIG. 8 is a process flow diagram illustrating a method 800 for notifying a user of a computing device of backhaul connection attributes of an available access point according to various embodiments. With reference to FIGS. 1-8, the method 800 may be implemented by a processor (e.g., the general processor 302 or another similar processor) of a computing device (e.g., the computing devices 118, 300).

In block 602, the processor may receive an indication of an attribute of a backhaul connection of a first access point as described above with reference to like numbered of method 600 illustrated in FIG. 6.

In block 604, the processor may display a first icon corresponding to the received indication of the attribute of the backhaul connection of the first access point as described above with reference to like numbered of method 600 illustrated in FIG. 6.

In block 802, the processor may receive a second indication of an attribute of a backhaul connection of a second access point. For example, in block 802, the processor may receive a second advertisement message broadcast from a second access point. In some embodiments, the second advertisement message may include an indication of an attribute of a backhaul connection of the second access point. In one example, the backhaul connection of the second access point is an Internet Protocol connection that provides a second communication pathway via a second core network between the second access point and the World Wide Web. For example, the computing device may receive an advertisement message indicating the attribute of the backhaul connection as a beacon frame or probe response frame over one or more Wi-Fi channels from a Wi-Fi access point. For example, the computing device may receive an advertisement message indicating the attribute of the backhaul connection as an availability advertisement over one or more Bluetooth channels from a Bluetooth access point.

In block 804, the processor may display a second icon corresponding to the received indication of the attribute of the backhaul connection of the second access point. For example, the processor may display a second icon corresponding to the attribute of the backhaul connection of the second access point indicated in the advertisement message prior to establishing a connection with the second access point. For example, the icon may be displayed in the list of available access points, such as a SSID list.

In determination block 606, the processor may determine whether an indication of a user selection of an access point is received. In response to determining an indication of a user selection of an access point is not received (i.e., determination block 606=“No”), the processor may continue to determine whether an indication of a user selection of an access point is received in determination block 606.

In response to determining an indication of a user selection of an access point is received (i.e., determination block 606=“Yes”), the processor may establish a connection with the selected access point in block 608. In various embodiments, the computing device and selected access point may exchange data via the established connection. In this manner, via the connection between the selected access point and the computing device, the computing device may send/receive data to the Internet when the selected access point's backhaul connection provides an Internet connection.

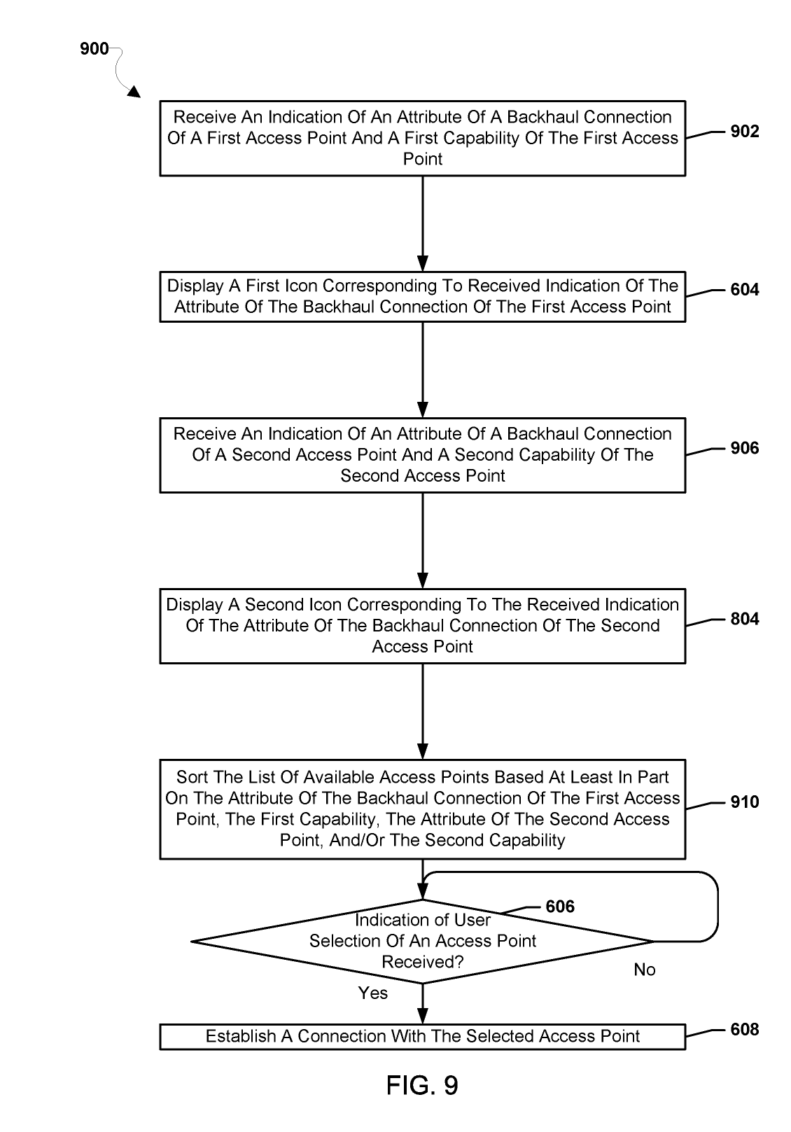

FIG. 9 is a process flow diagram illustrating a method 900 for notifying a user of a computing device of backhaul connection attributes of an available access point according to various embodiments. With reference to FIGS. 1-9, the method 800 may be implemented by a processor (e.g., the general processor 302 or another similar processor) of a computing device (e.g., the computing devices 118, 300).

In block 902, the processor may receive an indication of an attribute of a backhaul connection of a first access point and a first capability of the first access point. For example, in block 902, the processor may receive a first advertisement message broadcast from a first access point. In some embodiments, the first advertisement message may include an indication of an attribute of a backhaul connection of the first access point and a first capability of the first access point. In one example, the backhaul connection of the first access point is an Internet Protocol connection that provides a first communication pathway via a first core network between the first access point and the World Wide Web. In various embodiments, the first capability may be one or more of a channel load of the first access point and a number of devices connected to the first access point. As an example, the computing device may receive an advertisement message indicating the attribute of the backhaul connection and the capability of the access point as a beacon frame or probe response frame over one or more Wi-Fi channels from a Wi-Fi access point. As another example, the computing device may receive an advertisement message as an availability advertisement indicating the attribute of the backhaul connection and the capability of the access point over one or more Bluetooth channels from a Bluetooth access point.

In block 604, the processor may display a first icon corresponding to the received indication of the attribute of the backhaul connection of the first access point as described with reference to like numbered of method 600 illustrated in FIG. 6.

In block 906, the processor may receive an indication of an attribute of a backhaul connection of a second access point and a second capability of the second access point. For example, in block 906, the processor may receive a second advertisement message broadcast from a second access point. In some embodiments, the second advertisement message includes an indication of an attribute of a backhaul connection of the second access point and a second capability of the second access point. In one example, the backhaul connection of the second access point is an Internet Protocol connection that provides a second communication pathway via a second core network between the second access point and the World Wide Web. In various embodiments, the second capability may be one or more of a channel load of the second access point and a number of devices connected to the second access point. As an example, the computing device may receive an advertisement message indicating the attribute of the backhaul connection and the capability of the access point as a beacon frame or probe response frame over one or more Wi-Fi channels from a Wi-Fi access point. As another example, the computing device may receive an advertisement message as an availability advertisement indicating the attribute of the backhaul connection and the capability of the access point over one or more Bluetooth channels from a Bluetooth access point.

In block 804, the processor may display a second icon corresponding to the received indication of the attribute of the backhaul connection of the second access point as described with reference to like numbered of method 800 illustrated in FIG. 8.

In block 910, the processor may sort the list of available access points based at least in part on the attribute of the backhaul connection of the first access point, the first capability, the attribute of the second access point, and/or the second capability. In various embodiments, a computing device may use a sorting algorithm based on one or more attributes and/or one or more capabilities of the access points that are indicated to the computing device (e.g., in beacon frames, probe response frames, availability advertisements, etc.), or otherwise determinable by the computing device, to rank, order, and/or prioritize the access points. The attributes of a backhaul connection may be used as inputs to a weighted sorting algorithm. For example, each attribute or capability of each respective available access point identified by the computing device may be multiplied by a weight (or percentage) and the resulting value output by the algorithm for each respective available access point may be used to sort the available access points in the list of available access points displayed to the user. The weights may be pre-assigned and/or user selectable.

In determination block 606, the processor may determine whether an indication of a user selection of an access point is received. In response to determining an indication of a user selection of an access point is not received (i.e., determination block 606=“No”), the processor may continue to determine whether an indication of a user selection of an access point is received in determination block 606.

In response to determining an indication of a user selection of an access point is received (i.e., determination block 606=“Yes”), the processor may establish a connection with the selected access point in block 608. In various embodiments, the computing device and selected access point may exchange data via the established connection. In this manner, via the connection between the selected access point and the computing device, the computing device may send/receive data to the Internet when the selected access point's backhaul connection provides an Internet connection.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 400, 500, 600, 800, and 900 may be substituted for or combined with one or more operations of the methods 400, 500, 600, 800, and 900.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, various embodiments are not intended to be limited to the embodiments shown herein but are to be accorded the widest scope consistent with the following claims and the principles and novel features disclosed herein.

What is claimed is:

1. A method for indicating an attribute of a backhaul connection of an access point, comprising:
determining an attribute of a backhaul connection of an access point, wherein the backhaul connection is an Internet Protocol connection that provides a communication pathway via a core network between the access point and World Wide Web addresses;
generating, at the access point, an advertisement message including the attribute of the backhaul connection; and
broadcasting the advertisement message from the access point.

2. The method of claim 1, wherein the access point is a Wi-Fi access point and the advertisement message is a beacon frame or probe response frame.

3. The method of claim 1, wherein the access point is a Bluetooth access point and the advertisement message is an availability advertisement.

4. The method of claim 1, wherein the advertisement message is broadcast prior to establishment of a connection with the access point.

5. The method of claim 1, wherein determining the attribute of the backhaul connection of the access point comprises:
the access point pinging a World Wide Web addressable device over the backhaul connection; and
determining the attribute based on a response to the pinging.

6. The method of claim 1, wherein the attribute of the backhaul connection is an indication of whether a packet was successfully received from a World Wide Web addressable device remote from the access point over the backhaul connection.

7. The method of claim 1, wherein the attribute of the backhaul connection is a bandwidth of the backhaul connection.

8. The method of claim 7, wherein the attribute of the backhaul connection is a bit rate of the backhaul connection.

9. The method of claim 8, wherein the attribute of the backhaul connection is a type of the backhaul connection.

10. The method of claim 9, wherein the type of the backhaul connection is wired or wireless.

11. The method of claim 8, further comprising determining a capability of the access point,
wherein generating, at the access point, the advertisement message including the attribute of the backhaul connection comprises including the bit rate of the backhaul connection and the capability of the access point in the generated advertisement message.

12. The method of claim 11, wherein the capability of the access point is one or more of a channel load of the access point or a number of devices connected to the access point.

13. A method for notifying a user of a computing device of backhaul connection attributes of an available access point, comprising:
receiving, by the computing device, a first advertisement message broadcast from a first access point, wherein the first advertisement message includes an indication of an attribute of a backhaul connection of the first access point and wherein the backhaul connection of the first access point is an Internet Protocol connection that provides a first communication pathway via a first core network between the first access point and the World Wide Web; and
displaying, on the computing device, a first icon corresponding to the attribute of the backhaul connection of the first access point prior to establishing a connection with the first access point.

14. The method of claim 13, further comprising:
receiving, by the computing device, a second advertisement message broadcast form a second access point, wherein the second message includes an indication of an attribute of a backhaul connection of the second access point and wherein the backhaul connection of the second access point is an Internet Protocol connection that provides a second communication pathway via a second core network to the World Wide Web; and
displaying, on the computing device, a second icon corresponding to the attribute of the backhaul connection of the second access point,
wherein the first icon and the second icon are displayed in a list of available access points.

15. The method of claim 14, wherein the attribute of the backhaul connection of the first access point and the attribute of the backhaul connection of the second access point are bandwidths or bit rates of the backhaul connection.

16. The method of claim 14, wherein the first advertisement message includes a first capability of the first access point and the second advertisement message includes a second capability of the second access point, the method further comprising:
sorting the list of available access points based at least in part on the attribute of the backhaul connection of the first access point, the first capability, the attribute of the backhaul connection of the second access point, and the second capability.

17. The method of claim 16, wherein sorting the list of available access points is based on a result of applying a weighted sorting algorithm to the attribute of the backhaul connection of the first access point, the first capability, the attribute of the backhaul connection of the second access point, and the second capability.

18. The method of claim 17, wherein:
the attribute of the backhaul connection of the first access point and the attribute of the backhaul connection of the second access point are one or more of bandwidths, bit rates, and types;
the first capability is one or more of a channel load of the first access point and a number of devices connected to the first access point; and
the second capability is one or more of a channel load of the second access point and a number of devices connected to the second access point.

19. An access point, comprising:
a processor configured with processor-executable instructions to perform operations comprising:
determining an attribute of a backhaul connection of the access point, wherein the backhaul connection is an Internet Protocol connection that provides a communication pathway via a core network between the access point and World Wide Web addresses;
generating an advertisement message including the attribute of the backhaul connection; and
broadcasting the advertisement message from the access point.

20. The access point of claim 19, wherein the access point is a Wi-Fi access point and the advertisement message is a beacon frame or probe response frame or the access point is a Bluetooth access point and the advertisement message is an availability advertisement.

21. The access point of claim 19, wherein the advertisement message is broadcast prior to establishment of a connection with the access point.

22. The access point of claim 19, wherein the attribute of the backhaul connection is an indication of whether a packet was successfully received from a World Wide Web addressable device remote from the access point over the backhaul connection.

23. The access point of claim 19, wherein the attribute of the backhaul connection is one or more of a bandwidth of the backhaul connection, a bit rate of the backhaul connection, or a type of the backhaul connection.

24. The access point of claim 23, wherein:
the processor is configured with processor-executable instructions to perform operations further comprising determining a capability of the access point; and
the processor is configured with processor-executable instructions to perform operations such that generating the advertisement message including the attribute of the backhaul connection comprises including the bit rate of the backhaul connection and the capability of the access point in the generated advertisement message.

25. The access point of claim 24, wherein the capability of the access point is one or more of a channel load of the access point or a number of devices connected to the access point.

26. A computing device, comprising:
a processor configured with processor-executable instructions to perform operations comprising:
receiving a first advertisement message broadcast from a first access point, wherein the first advertisement message includes an indication of an attribute of a backhaul connection of the first access point and wherein the backhaul connection of the first access point is an Internet Protocol connection that provides a first communication pathway via a first core network between the first access point and the World Wide Web; and
displaying a first icon corresponding to the attribute of the backhaul connection of the first access point prior to establishing a connection with the first access point.

27. The computing device of claim 26, wherein:
the processor is configured with processor-executable instructions to perform operations further comprising:
receiving a second advertisement message broadcast form a second access point, wherein the second message includes an indication of an attribute of a backhaul connection of the second access point and wherein the backhaul connection of the second access point is an Internet Protocol connection that provides a second communication pathway via a second core network to the World Wide Web; and
displaying a second icon corresponding to the attribute of the backhaul connection of the second access point; and
the first icon and the second icon are displayed in a list of available access points.

28. The computing device of claim 27, wherein:
the first advertisement message includes a first capability of the first access point and the second advertisement message includes a second capability of the second access point; and
the processor is configured with processor-executable instructions to perform operations further comprising sorting the list of available access points based at least in part on the attribute of the backhaul connection of the first access point, the first capability, the attribute of the backhaul connection of the second access point, and the second capability.

29. The computing device of claim 28, wherein the processor is configured with processor-executable instructions to perform operations such that sorting the list of available access points is based on a result of applying a weighted sorting algorithm to the attribute of the backhaul connection of the first access point, the first capability, the attribute of the backhaul connection of the second access point, and the second capability.

30. The computing device of claim 29, wherein:
the attribute of the backhaul connection of the first access point and the attribute of the backhaul connection of the second access point are one or more of bandwidths, bit rates, and types;
the first capability is one or more of a channel load of the first access point and a number of devices connected to the first access point; and
the second capability is one or more of a channel load of the second access point and a number of devices connected to the second access point.
